(19) United States
(12) Patent Application Publication
(10) Pub. No.: US 2004/0180691 A1
(43) Pub. Date: Sep. 16, 2004

(54) Hat cell phone or wireless device for hands-free user-safe operation

(76) Inventor: Peter Cascone, New York, NY (US)

Correspondence Address: EVELYN M. SOMMER, 30TH FLOOR, 825 THIRD AVENUE, NEW YORK, NY, 10022, US

(21) Appl. No.: 10/385,896

(22) Filed: Mar. 12, 2003

(51) Int. Cl. H04M 1/00; H04B 1/38

(52) U.S. Cl. 455/557; 455/556.1; 455/550.1

(57) ABSTRACT

A cellphone or wireless phone device has separate components which are carried or mounted in corresponding parts of a hat, cap, or other headgear worn by the user. Preferably, the voice pickup component is carried in a forward brim or visor, the antenna is lined in a rear part on an inner layer of the hat, the speaker earpiece is attached to one or both sides of the hat, the keypad is mounted in the fabric layers or inner liner of the hat, and the electronic circuitry and battery may is mounted in an inner part or inner liner of the hat. The battery may have recharge pins or points exposed for attachment to an external recharging unit. A metallized RF-blocking layer may be provided in the fabric layers of the hat to block RF radiation from the antenna from the user's head. The device includes various embodiments for mounting a cellphone or cordless phone in a sports cap, hamburg hat, sports helmet, or pith helmet.

### FIELD OF THE INVENTION

This invention generally relates to a hat or cap device having a cellphone or other wireless communication device mounted therein for hands-free, user-safe operation.

### BACKGROUND ART

Cellphones, cordless phones, wireless phone devices, wireless messaging devices, etc. have entered into widespread usage throughout the world. People using cellphones and other wireless communication devices often find it awkward to operate a phone in many circumstances. For example, it is awkward to hold a cellphone for conversations while driving a vehicle or where one or both hands are occupied with an ongoing activity. In many localities in the united States and other countries of the world, using a cellphone in such circumstances is deemed unsafe and made illegal.

Carrying and storing a cellphone or wireless phone device on one's person can also be inconvenient, unsightly, or uncomfortable. Cellphones worn on the belt can be awkward or uncomfortable when the user sits down or leans back against a seat. when carried in the shirt or trousers pocket, they can create unsightly bulges or distortions in one's clothing. when carried in a purse or backpack, the user can be inconvenienced by having to open or unzip the carry pack and fumble around with its contents to find the phone.

The prolonged use of wireless transmitting devices close to one's head may also have deleterious health effects. In some countries, cellphone users have adopted wearing metallized shields on their head or around their ear to block exposure of soft brain tissue to RF radiation.

### SUMMARY OF THE INVENTION

A principal object of the present invention is to solve the problems of awkwardness, inconvenience, or unsafe conditions created by the use of cellphones and other wireless phone devices for the user. A specific object is to provide a device that allows a cellphone to be carried and operated in a “hands-free” manner and with protection of the user from prolonged exposure to RF radiation.

In accordance with the present invention, the components of a cellphone or wireless phone device has separate components which are carried or mounted in corresponding parts of a hat, cap, or other headgear worn by the user. The cellphone microphone or voice pickup component may be carried in the forward brim of a hat or visor of a cap, the antenna may be lined in the rear part of the hat or cap, the speaker earpiece may be attached to one or both sides of the hat, the keypad may be mounted between the fabric layers of the visor of a cap or the inner liner of a hat or headgear, and the electronic circuitry and battery may be mounted in an internal part or inner liner of the hat. The hat may have battery recharge pins or points exposed for attachment to an external recharging unit. A metallized RF-blocking layer may be provided on an inner layer of the hat to block RF radiation from the antenna from the user's head.

The cellphone components may be placed in selected parts or positions of the hat, cap or headgear depending upon its shape, structure, and mode of use. Various embodiments for mounting a cellphone or cordless phone in a sports cap, hamburg hat, sports helmet, or pith helmet are described herein.

Other objects, features and advantages of the present invention are described in detail below in conjunction with the drawings, as follows:

### BRIEF DESCRIPTION OF THE DRAWINGS

FIGS. 1A, 1B, and 1C are side, top, and bottom views of a first embodiment having cellphone components mounted in parts of a sports or casual wear cap.

FIGS. 2A, 2B, and 2C show a second embodiment of cordless phone components mounted in parts of a sports or casual wear cap.

FIG. 3 shows a third embodiment of cellphone components mounted in parts of a hamburg type hat.

FIG. 4 shows a fourth embodiment of cellphone components mounted in parts of a sports helmet.

FIG. 5 shows a fifth embodiment of cellphone components mounted in parts of a pith helmet.

FIGS. 6A and 6B show embodiments of a battery recharge device for the hat cellphone devices of the present invention.

### DETAILED DESCRIPTION OF THE INVENTION

A conventional cellphone or cordless phone has the following typical components: a microphone or voice pickup; a speaker or earphone; a keypad; an antenna for transmitting wireless signals; electronic circuit board; and a battery. A cordless phone typically transmits an RF signal over short distances to a base station powered by wall current. A cellphone differs from a cordless phone in that it transmits a stronger RF signal at different frequencies which can be picked up by a cellular station receiving antenna in a wider area. In both instances of the present invention, the phone components are distributed and carried in appropriate parts of a hat, cap, or headgear for convenient, hands-free portability and user-safe operation. It may be desirable in cellphone versions to include an RF-blocking shield as a component to be mounted in the hat or cap.

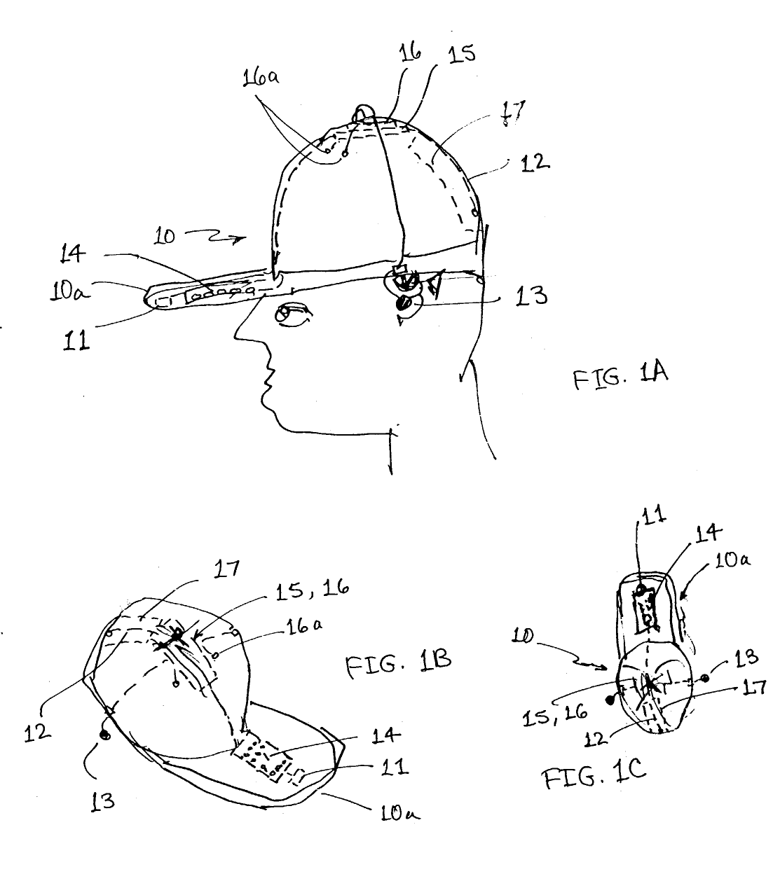

As shown in FIGS. 1A to 1C, the cellphone components are mounted in parts of a sports or casual wear cap 10. The cellphone microphone or voice pickup component 11 is preferably carried in the forward brim or visor 10a of the cap 10 where it can pick up the sound of the user's voice. The antenna 12 is lined in the inner fabric layer of the rear part of the cap. The speaker is carried in an earpiece 13 attached to one or both sides of the cap.

The keypad 14 is mounted between the fabric layers of the visor 10a of the cap. The keypad face and buttons may be exposed through an aperture in the underside fabric layer of the visor. Alternatively, the underside layer of the cap may be formed as a touchpad or membane pad with button pads coupled to the keyboard substrate carried by the visor inner substrate.

The electronic circuitry 15 and battery 16 are mounted to the inner liner of the cap at the top center part where there is normally space between the cap and the top of the user's head. If the circuit board 15 is of the type that uses a memory chip or insertable microcard to store the phone ID data and/or phone numbers and other user-entered data, the circuit board is mounted in a manner that exposes the access door or tab to the memory chip or microcard on the inside of the cap. The chip or microcard may also store voice recognition templates input by the user for recognition of spoken commands or other words to control various phone functions (such as voice command or voice dialing). All of the cellphone components are connected to the circuit board 15 by wires sewn into the inner fabric layer of the cap.

The battery may be removable from inside the cap for recharging, or may have recharge pins or points 16a exposed on the inside or outside of the cap 10 where they can be connected to an external recharging unit. A metallized RF-blocking shield or layer 17 may be provided in the inner fabric layer of the cap between the antenna 12 and the user's head to block RF radiation from the antenna from reaching the user's head. The RF-blocking shield may be formed by a laminate of a metallized film on a flexible substrate such as paperboard or foam board.

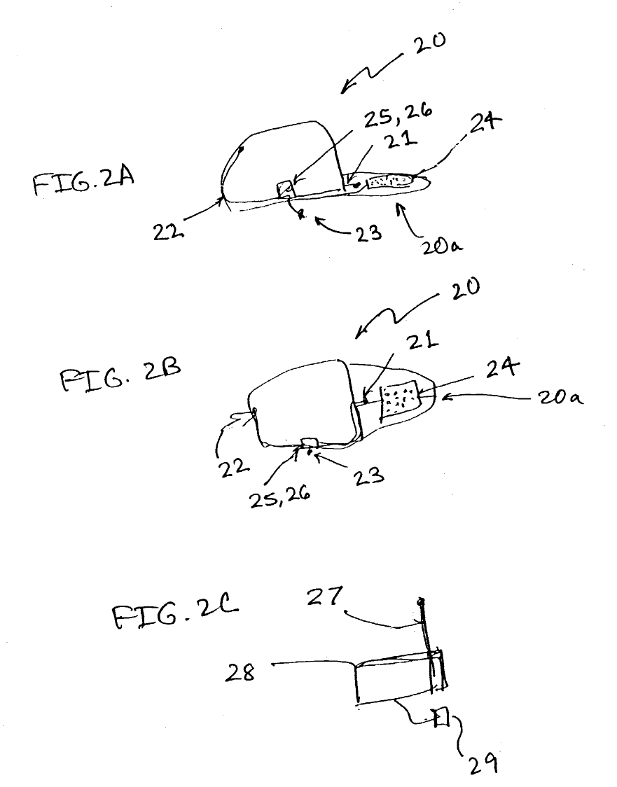

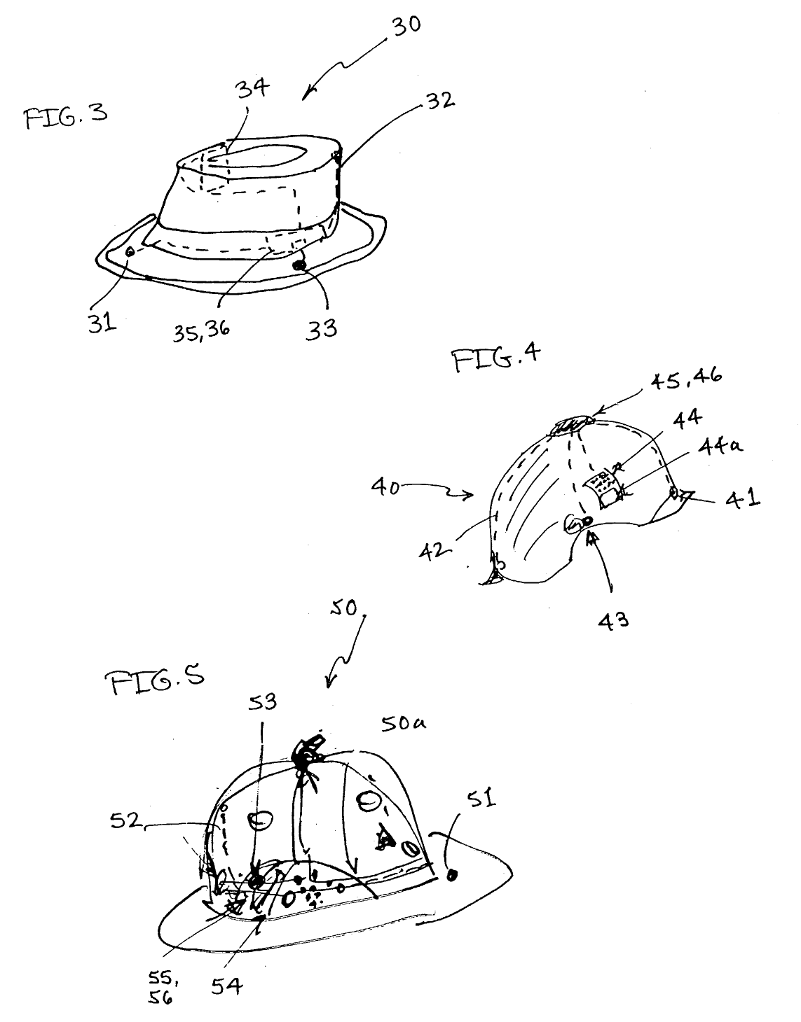

In another embodiment shown in FIGS. 2A to 2C, cordless phone components are mounted in a similar manner in appropriate parts of a sports or casual wear cap 20. The phone voice pickup component 21 is carried in the visor 20a of the cap 20. The antenna 22 is lined in the inner fabric layer around the rear part of the cap. The speaker is carried in the earpiece 23 attached to one side (or both sides) of the cap. The keypad 24 is mounted in the fabric layers of the visor 20a. The circuit board 25 and battery 26 are mounted in the inner liner at one side of the cap (the space requirements are less for a cordless phone compared to a cellphone). The RF signal transmitted from the cap are received by the antenna 27 of a base station 28 in the user's premises which is powered from a power outlet 29.

In the embodiment shown in FIG. 3, a hamburg type hat 30 is fitted similarly with cellphone components including voice pickup component 31, antenna 32, earpiece 33, keypad 34, and circuit board 35 and battery 36.

In the embodiment shown in FIG. 4, a sports helmet 40 is fitted with voice pickup component 41, antenna 42, speaker 43, keypad 44 (and insertable microcard 44a), and circuit board 45 and battery 46. For sports use, all of the components are mounted on the inside of the helmet.

In the embodiment shown in FIG. 5, a pith helmet 50 is fitted with voice pickup component 51, antenna 52, speaker 53, keypad 54, circuit board 55 and battery 56. For the pith helmet, all of the components can be mounted between the inner liner fitted on the user's head and the shell of the helmet.

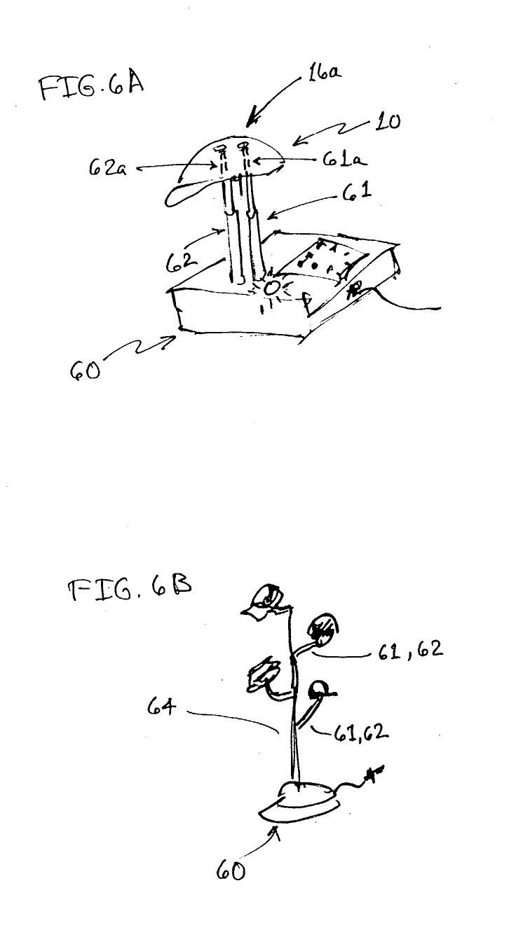

In FIG. 6A, a battery recharger unit 60 for a hat cellphone device, such as the cap cellphone 10 of FIGS. 1A to 1C, has a pair of probes 61, 62 sheathing electrically conductive contacts 61a, 61b which are coupled to the recharge pins or points 16a exposed on the inside of the cap 10. The cap cellphone can thus be conveniently recharged when not being used. A multi-hat recharge stand is shown in FIG. 6B similarly using a pair of probes 61, 62 for charging each hat placed on the stand.

Although the invention has been described with reference to the preferred embodiments, it will be appreciated that many other variations and modifications thereof may be devised in accordance with the principles disclosed herein. The invention, including the described embodiments and all such variations and modifications thereof, is defined in the following claims.

1. A cellphone or wireless phone device having separate components including a voice pickup, an antenna, a speaker earpiece, a keypad, electronic circuitry and a battery,
wherein said components are separately mounted in selected parts of a hat, cap, or headgear.

2. A cellphone or wireless phone device according to claim 1, wherein the voice pickup is mounted in a forward brim or visor of the hat, cap, or headgear.

3. A cellphone or wireless phone device according to claim 1, wherein the antenna is mounted in a rear part of the hat, cap, or headgear.

4. A cellphone or wireless phone device according to claim 1, wherein the speaker earpiece is mounted on at least one side of the hat, cap, or headgear adjacent an ear of the user.

5. A cellphone or wireless phone device according to claim 1, wherein the circuit board is mounted in a space in a top center portion on the inside of the hat, cap, or headgear.

6. A cellphone or wireless phone device according to claim 1, wherein the circuit board is mounted on an inner liner on the inside of the hat, cap, or headgear.

7. A cellphone or wireless phone device according to claim 1, wherein the battery has recharge pins or points which are exposed on the hat, cap, or headgear for attachment to an external recharging unit.

8. A cellphone or wireless phone device according to claim 7, further including an external recharging unit having a pair of electrically conductive probes for coupling to the recharge pins or points of the hat, cap, or headgear.

9. A cellphone or wireless phone device according to claim 1, wherein a metallized RF-blocking layer is provided on an inner part of the hat, cap, or headgear positioned between the antenna and the user's head.

10. A cellphone or wireless phone device according to claim 1, wherein said components are separately mounted in selected parts of a sports cap having a visor.

11. A cellphone or wireless phone device according to claim 1, wherein said components are separately mounted in selected parts of a hamburg type hat having an inner liner.

12. A cellphone or wireless phone device according to claim 1, wherein said components are separately mounted in selected parts within the inside of a sports helmet.

13. A cellphone or wireless phone device according to claim 1, wherein said components are separately mounted in selected parts of a pith helmet having an inner supporting liner.
